(19) United States
(12) Patent Application Publication
(10) Pub. No.: US 2007/0055635 A1
(43) Pub. Date: Mar. 8, 2007

(54) METHOD AND APPARATUS FOR PERFORMING MOBILE TRANSACTIONS

(75) Inventors: Rajesh Kanapur, Ypsilanti, MI (US); David L. Korman, Ann Arbor, MI (US); Chunhui Li, Novi, MI (US)

Correspondence Address: ARTZ & ARTZ, P.C., 28333 TELEGRAPH RD., SUITE 250, SOUTHFIELD, MI, 48034, US

(73) Assignee: MOBITRAN LLC, Ypsilanti, MI (US)

(21) Appl. No.: 11/162,381

(22) Filed: Sep. 8, 2005

(51) Int. Cl. G06F 17/60

(52) U.S. Cl. 705/75

(57) ABSTRACT

A system and method for forming transactions between a first mobile user and a merchant is set forth. An issuing bank and acquiring bank may also be provided for receiving and transferring funds. A transaction controller coupled to the mobile user device, the merchant device, the issuing bank, and the acquiring bank may be used to securely control the transactions therebetween. The transaction controller verifies the first user and receives a transaction amount corresponding to the transaction from the first user. The transfer of money is performed by the transaction controller between the issuing bank and the receiving bank in response to receiving the transaction amount.

### TECHNICAL FIELD

The present application is generally related to electronic transactions and, more particularly, to mobile transactions for purchasing goods.

### BACKGROUND

Various forms of payment have been used in transactions. Physical exchange of notes and coins has been used for many centuries. In these cases, a physical exchange of the money is performed. Now, various types of money representations are used including checks and credit cards. For checks and credit cards, various information is exchanged between the parties to allow transfers of money to occur. Various types of networks such as a credit card network are involved with credit card companies. Banks pay rights to use various networks. Also, various types of E-commerce have developed with various levels of security. No physical contact between a buyer and seller takes place over the Internet.

Cellular phones have proliferated into today's society. In some cases, cellular phones have replaced landline phones. Early cellular networks had limited data capacity. Newer cellular networks have increased the data capacity thereon. Third generation cellular networks allow access to the Internet for users. Until now, synergy between transactions and mobile commerce has not existed. It would therefore be desirable to allow use of mobile devices to perform various secure commerce transactions.

### SUMMARY

The present invention provides a method and apparatus for providing secure commerce using mobile devices.

In one aspect of the invention, a transaction system includes a first mobile user device having a user interface for entering a security code to enable communication with a merchant device, the merchant device communicating with the first user, an issuing bank and an acquiring bank. A transaction controller is coupled to the first user, the merchant device, the issuing bank, and the acquiring bank. The transaction controller verifies the first user and receives a transaction amount corresponding to a transaction from the first user. The transaction controller authorizes the transfer of money to the merchant by transferring funds from the issuing bank to the receiving bank.

In a further aspect of the invention, the merchant device may be a point-of-sale device that is either connected or is not connected directly to the transaction controller. A merchant device that is connected may be coupled wirelessly or through a wire. Such a merchant device may be suitable in high value transactions. Examples of merchant devices that may not be coupled are vending machines and gas pumps. In a non-connected situation, a collection device may be provided by the owner of the point-of-sale devices so that the transferring of funds may occur.

One advantage of the invention is that the present system is convenient, easy to use, and quick to use. Also, the consumer is also free to choose a bank and a cellular phone provider. Also, the system may easily be implemented in open source and non-proprietary technology to facilitate deployment into the infrastructure.

The present system allows anytime, anywhere secure mobile transactions using a mobile device. Security may be provided in various manners to protect the integrity of the system. Security code access to the transaction system, program a wallet within the device may be provided before any transactions or communications with merchant devices are made. Also, transactions between remote services, local services, and between various users may be enabled. Thus, the various user devices become an integral part of the transaction including one source of security.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a block diagrammatic view of a transaction system according to the present invention.

FIG. 2 is a sequence chart illustrating a first embodiment of a transaction according to the present invention.

FIG. 3 is a sequence chart illustrating a second embodiment of a transaction according to the present invention.

FIG. 4 is a sequence chart illustrating a third embodiment of a transaction according to the present invention.

FIG. 5 is a sequence chart illustrating a fourth embodiment of a transaction according to the present invention.

FIG. 6 is a sequence chart of a fifth embodiment of a transaction according to the present invention.

### DETAILED DESCRIPTION OF THE PREFERRED EMBODIMENT

In the following figures the same reference numerals will be used to illustrate the same components. While various embodiments are set forth below, various permutations would be evident to those skilled in the art.

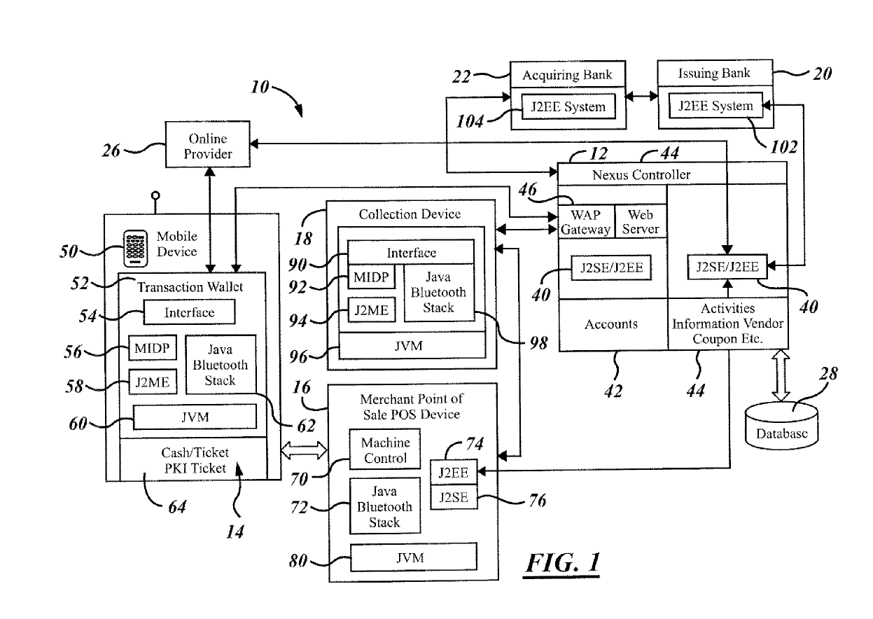

Referring now to FIG. 1, a transaction system 10 according to the present invention is illustrated. The transaction system 10 includes a transaction controller 12 coupled to a mobile device 14. Transaction controller 12 is also coupled to a point-of-sale device 16. In some embodiments, a collection device 18 may be coupled to both the point-of-sale device 16 and the transaction controller 18. The transaction controller 12 may also be coupled to an issuing bank 20, which in turn is coupled to an acquiring bank 22. The transaction controller 12 may also be coupled to the acquiring bank 22. An online provider 26, in some embodiments, may be coupled to transaction controller 12 and mobile device 14. It will be evident to those skilled in the art based upon the description below that some of the various components of the system may not be required for specific embodiments.

Transaction controller 12 may also be coupled to a database 28 that stores information therein. Such information may include client information, transactions, transaction codes and account information.

Transaction controller 12 may include various operating applications or supporting frameworks such as Java™. One or several protocol boxes 40 may be included in the transaction controller. As illustrated, the supporting framework includes Java™ 2 Standard Edition (J2SE) and Java™ 2 Enterprise Edition (J2EE). Various accounts 42 may also be stored within the transaction controller. The accounts 42 may be set forth within the transaction controller 12 or within the database 28. A web server 44 may also be included within the transaction controller. The web server allows communication over the Internet such as an HTTP format. TCP/IP protocol may also be used in various aspects of the invention. Also, transaction controller 12 may also be coupled to wireless access protocol (WAP) gateway 46. The WAP gateway 46 allows wireless cellular phone-type calls directly to or through a network to the transaction controller 12. Various activities, information and vendor coupons 44 may also be set forth within the transaction controller 12. The activities information includes purchasing information and coordination of communications between various devices. These functions will be described below with respect to the individual embodiments.

Mobile device 14 may include various types of devices such as a cellular phone, personal computer, personal digital assistant, or other mobile-type device. The cellular phone 14 has a security user interface such as keypad 50 that may be used for entering various identifying information such as a security code. The security code may be required by the device to enable access to the transaction system or software contained therein. Each transaction may require a separate reentry into the system via the security code. Therefore, if the first user device is lost or misplaced, unauthorized transactions may not be made. Mobile device 14 may also include a transaction wallet 52 that may be only accessible through the security code. The transaction wallet 52 may include various functions that include the system communications and programs therein. For example, transaction wallet 52 may include an interface 54 for interfacing directly with the transaction controller 12. This interface is preferably a wireless interface. While a cellular-type network is envisioned, various other types of technology including satellite technology may be used. The transaction wallet 54 may also include a mobile information device profile (MIDP) 56. The mobile information device profile provides a code to identify the device to the system. A Java™ 2 Micro Edition block 58 may also be included to enable Java™ communications. A Java™ virtual machine (JVM) may also be included to provide runtime environment for the mobile transaction application.

A Java Bluetooth® stack 62 may also be included in the transaction wallet 52. The Java Bluetooth® stack may be set forth so that Bluetooth® protocol may be used to communicate with various point-of-sale devices on a local level. A memory 64 may also be included in transaction wallet 52. The memory 64 may store various types of information such as a cash counter, a ticket, and also security related information such as a PKI key to enable secure transactions between various devices. The PKI encryption method using public/private key pairs is a system that provides an encryption technique so that the mobile device 14 may securely communicate with a point-of-sale device 16 or to the transaction controller 12 so that the communications cannot be intercepted. That is, the mobile device 14 and the point-of-sale device may use PKI encrypted XML to communicate therebetween. The PKI encrypted XML may use the Bluetooth® interface. Other encryption techniques may also be used. The user device securely communicates not only with the cellular capability but also with the secondary direct interface such as Bluetooth®, optical or the like. In this manner a high level of security is provided.

The merchant point-of-sale device (POS) 16 may include machine control 70 that includes various transactions. A Java Bluetooth® stack 72 similar to that of 62 may also be included. A Java™ 2 EE box 74 may provide Java™ 2 Enterprise Edition thereto. Also, Java™ 2 SE (J2SE) box 76 provides Java™ 2 Standard Edition to the device. A Java™ virtual machine 80 is included to provide a run time environment for the mobile transaction application within the device.

The merchant point-of-sale device 16 communicates with the mobile device 14. Also, various embodiments include a point-of-sale device that is coupled directly to the transaction controller 22 using J2EE 74 and J2SE 76 using TCP/IP protocol to redeem funds from transactions initiated by the mobile device 14. Other embodiments of the merchant point-of-sale device 16 include a device that is a stand alone device. The stand alone device cannot communicate directly with transaction controller 12 but indirectly therewith. That is, a collection device 18 may be used to download various information using Java Bluetooth® or otherwise from the collection device 18 the various transactions by various mobile devices may be redeemed. The collection device 18 includes an interface 90, mobile device information profile (MDIP) 92, Java™ 2 Micro Edition (J2ME) 94, a Java™ Virtual Machine (JVM) 96, and a Java Bluetooth® stack 98. Various identifiers may be transferred between the mobile device and the transaction controller through the collection device 18. For example, a transaction communicated from the point-of-sale device may include the mobile device identification with the corresponding transaction amount. The collection device 18 may thus be coupled to the transaction controller in various manners such as through a cellular network.

Online digital content provider 26 may provide various types of digital content desired to be loaded on the mobile device 14. For example, ring tones, music, pictures, video clips, and various other types of information may be provided to the device. Online digital content provider 26 is coupled to the mobile device 14 using hypertext transfer protocol (http/https) and to the transaction controller 12 using the same protocol.

Issuing bank 20 may also include a J2EE system 102 which communicates with the transaction controller 12. The transaction controller 12 and issuing bank 20 may be one and the same, or be separate entities. The issuing bank 20 is coupled to acquiring bank 22 which may also communicate with J2EE system 104.

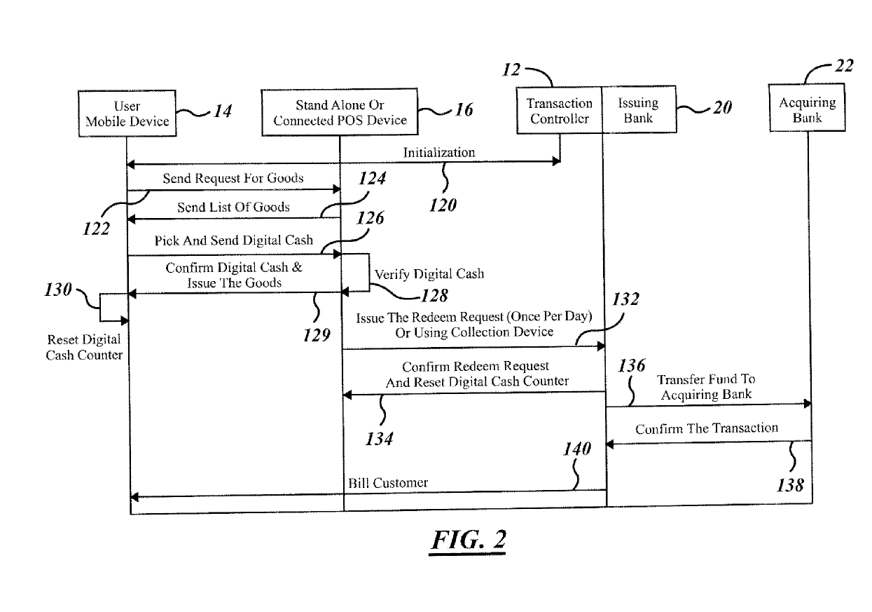

Referring now to FIG. 2, a sequence of events illustrating a transaction is illustrated. The system is initialized by storing the transaction wallet 52 on the mobile device. Also, the various point-of-sale devices 16 are also initialized. The initialization step is illustrated as arrow 120. The banks are also initialized. The initialization takes place in various ways including providing digital certificates to the various users so that secure transactions may be performed. The following description may be used for point-of-sale device 16 including both stand alone devices or connected point-of-sale devices. A request for the user to provide a security code to enable access to the transaction system or wallet on the first security device is set forth. A proper security code will allow the mobile user device to communicate with the point-of-sale device 16. After initialization, step 122 may be performed. In step 122, the mobile device 14 sends a request for a list of goods to the point-of-sale device 16. The mobile device 14 receives a list of goods from the point-of-sale device which is displayed on a display on the mobile device 14. Various types of goods may be provided, including vending machine-type devices or other type of goods including gasoline, for example. An amount of digital cash may be stored within the transaction wallet 52 of the mobile device 14. Digital cash is selected in step 126 and sent to the point-of-sale device 16 along with the selection. It is envisioned that both the pick and the digital cash may be selected with the push of one button. However, different selection criteria may be used. In step 128, the digital cash is verified by the point-of-sale device using the encryption and securities described above. In step 129, the digital cash may be confirmed along with issuance of the goods. In step 130, the digital cash amount may be reset within the user's wallet. In step 132, the point-of-sale device may issue a request to redeem the transaction or transactions through a network or through the collection device 18 described above. The transaction controller 12 receives the redemption request and generates a confirmation of the redeemed request and resets the digital cash counter within the point-of-sale device 16 in step 134. In response to the request, the issuing bank 20 transfers funds in step 136 from the issuing bank to the acquiring bank. A transaction confirmation may be provided from the acquiring bank to the issuing bank in step 138. The customer may be billed from the transaction controller 12 in step 140. The customer may be billed directly in a credit-type situation, or may be billed in a debit manner in which a prefunded account is set up with the transaction controller 12.

When a redeeming request is provided from the point-of-sale device, identifiers identifying the transaction amount and which mobile device 14 are provided to the transaction controller 12 so that a proper account may be billed or debited.

It should be noted that the transaction wallet 52 within the mobile device does not act as actual cash but rather as a preferred limit on transactions at a point-of-sale device 16. That is, the transaction wallet is reduced when the goods are received. However, the transaction controller 12 does not know of the transaction until the redemption request is received. Tracking the account is provided within the transaction controller 12. Thus, when a redemption is made by the point-of-sale device 16, the account is debited or the user is billed at that time. The wallet is set up so that minimum amount transactions may be easily performed without interfacing with the transaction controller. The point-of-sale device 16 may thus request the redemption of several transactions all at one time to increase efficiency of the system. That is, after a certain dollar amount has been reached, a request may be generated. Also, a request may be generated once a day or once every predetermined period of time.

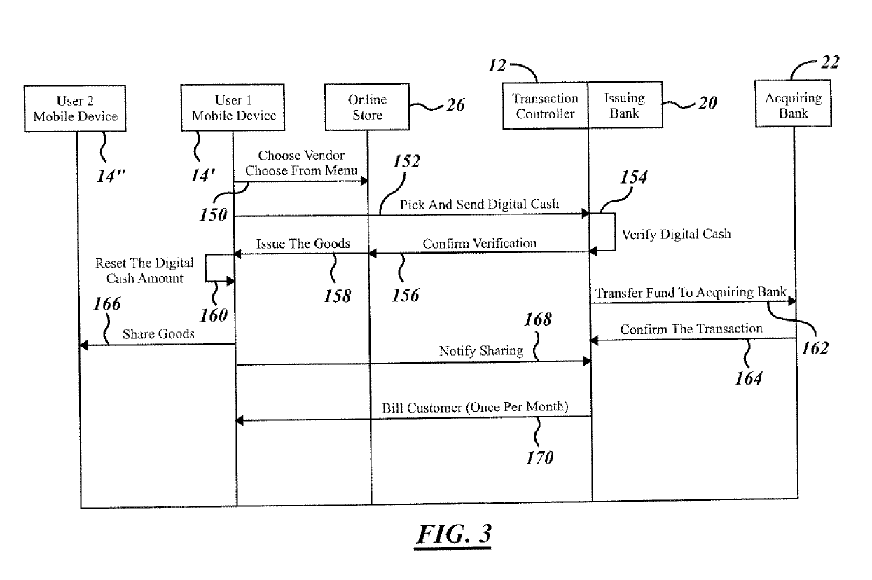

Referring now to FIG. 3, each of the following embodiments may also include the initialization step 120 shown above in FIG. 2 including the entering of a security code to enable the user device to communicate in the transaction system. Therefore, this step may be eliminated from the following embodiments. In this embodiment, online store 26 is set forth. The mobile device 14′ may be used to locate a vendor in various ways, including using the Internet. In step 150, a vendor is chosen and a selection is selected from a menu. This may be performed by browsing the Internet with the mobile device. In step 152, the amount of digital cash is selected. This may be performed at the same time the selection is performed. In this embodiment, the digital request may be provided directly to the transaction controller 12 which verifies the digital cash in step 154 and confirms verification to the online store in step 156. The online store 26 may issue the goods in step 158 in response to the confirmation of goods. Once the goods are provided to the mobile device, the digital cash amount may be reset in step 160 within the wallet 52 described above. Funds may be transferred from the issuing bank 20 to the acquiring bank 22 in step 162. The transaction may be confirmed in step 164.

This invention is particularly suitable for downloading various digital information from the Internet. This may also allow the sharing of digital content from a first user device 14′ to a second user device 14″ as shown in step 166. By sharing goods, the first user's certificate may be substituted with the second user's certificate in step 14″. The first user device 14″ may notify the transaction controller 12 of the transaction in step 168. The sharing notification will provide an identity User 1 an music details shared. User 1 will be billed accordingly.

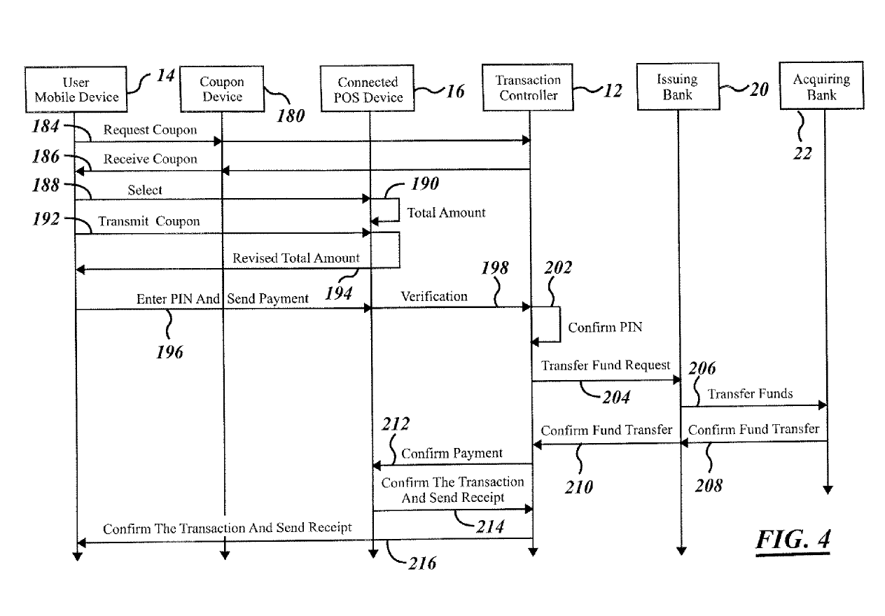

Referring now to FIG. 4, the following scenario is set forth that is particularly suitable for various types of large monetary transactions. It may be desirable for larger transactions to have more authentication and security than smaller transactions. In this embodiment, a connected point-of-sale device 16 will be employed. Also, an optional coupon device 180 that may be part of the transaction controller 12, part of the point-of-sale device 16, or a stand alone device is set forth. In this embodiment, initialization of the system may be provided as set forth above. In step 184, a coupon may be requested. As mentioned above, the coupon may be requested directly from the coupon device 180 or from the transaction controller 12. When a coupon is requested, a coupon device 180 may also inform the transaction controller 12 of the coupon that is present for the particular user. In that way, the transaction controller 12 may take into account the amount of the coupon when billing the user. In step 186, the coupon is receiving by the mobile device 14. The mobile device 14 may be provided a coupon by entering a premises using GPS location or the like. A coupon device 180 may also be specifically requested. An indicator or the like is provided to the user for the presence of the coupon within the mobile device 14. A screen selection or other icon may be used.

When a specific item is desired to be purchased, the user device selects the item on the mobile device in step 188. The account from which to draw may also be chosen at this point. Using one account or choosing between two accounts at the same or different banks may be performed. The amount is totaled at the point-of-sale device 16 in step 190. In step 192, the coupon may be transmitted to the point-of-sale device and a revised total may be provided to the mobile device 14. This is performed in step 194. Also, the steps may be streamlined by providing the coupon directly with the selection. In step 196, security is provided from the mobile device to the point-of-sale device so that the transaction can be verified in step 196 between the point-of-sale device and the transaction controller 12. As can be seen when compared with the embodiments above, the personal identification number provides added security particularly to high value transactions. In step 198, the verification is provided from the point-of-sale device to the transaction controller 12. The transaction controller 12 confirms the personal identification number in step 202. At this point or at some future time the transaction controller 12 may initialize the transfer of funds in step 204 to the issuing bank 20. In step 206, funds may be transferred from the issuing bank to the acquiring bank in step 206. A confirmation is provided in step 208 from the acquiring bank 22 to the issuing bank 20 to confirm the transfer of funds. Also, the issuing bank 20 provides the transaction controller 12 a confirmation in step 210. Payment is confirmed in step 212 to the point-of-sale device 16. A receipt and confirmation transaction may be provided to the transaction controller 12 in response to the confirmation of payment in step 214. The user in step 216 may be notified with a receipt and a confirmation that the transaction was processed. It should be noted above that communications between the point-of-sale device 16, the coupon device 180, and the user device 14 may all be performed using Bluetooth® communications.

As mentioned above, the coupon step is optional. Therefore, the above scenario minus steps 184 and 186 with regard to the coupons may not be provided for a transaction. That is, for a large transaction over a predetermined dollar amount, the transaction controller 12 may be required to authenticate the transaction.

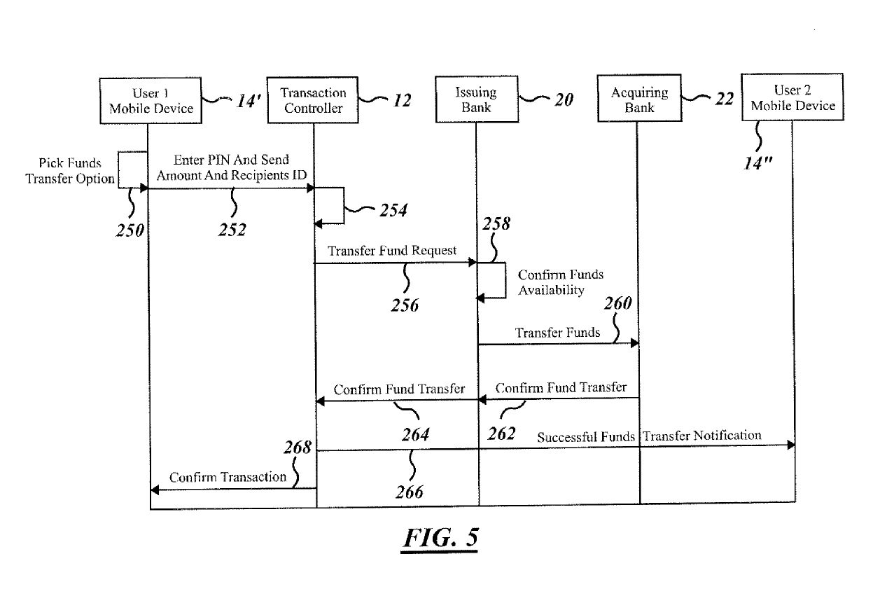

Referring now to FIG. 5, the mobile user device 14′ may be used to transfer funds to a second user device 14″. In step 250, funds transfer option may be selected at the mobile device 14′. A personal identification number and an amount to send with the recipient's ID may be selected in step 252. The transaction controller 12 confirms the personal identification number in step 254 and a fund request in step 256 to issuing bank 20 may be performed. The issuing bank 20 may confirm the availability of funds in step 258. In step 260, funds may be transferred to acquiring bank 22 from the account within the issuing bank 20. In step 262, the fund transfer may be confirmed to the issuing bank 20 from the acquiring bank 22. In step 264, the fund transfer is confirmed to the transaction controller 12. In step 266, a transfer notification is provided from the transaction controller 12 to the mobile device 14″. Also, in step 268 the successful transaction is communicated to the mobile user device 14″ in step 268.

Thus, as can be seen, a centralized transaction controller 12 may be used to control transactions between a mobile device 14 and point-of-sale devices, online retailers, or other mobile devices. The present invention advantageously allows this to happen while security is maintained at a high level.

It should be noted that the transfer between two users may be between two accounts for the same user. Of course, in this case the successful transfer notification step 266 would be provided to the first mobile device 14′. Various types of accounts such as checking, savings, credit cards, money markets or the like may be selected. Such accounts may be at one bank or a multitude of banks.

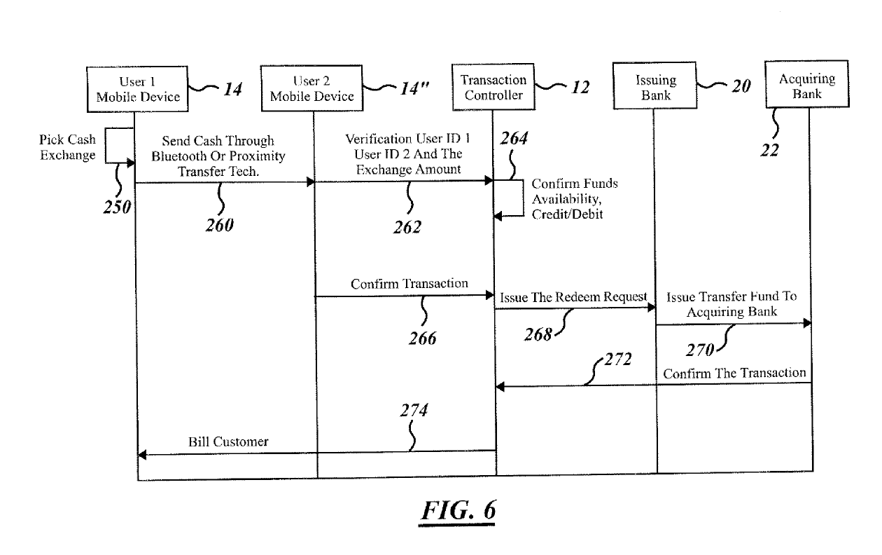

Referring now to FIG. 6, an embodiment for transferring credit or digital cash between a first mobile user device 14 and a second mobile user device 14″ is illustrated. In step 250, an amount of cash to exchange is selected in the first user device. In step 260, the selected amount and the identification of the first (sending) device and the second (receiving) device is sent through various manners such as Bluetooth® or other proximity transfer technology. In step 262, verification is provided for the first user ID, the second user ID, and the amount to be exchanged. In step 264, the amount of funds available to debit and credit is determined in the transaction controller 12. In step 266, the amount of transaction is confirmed to the second mobile device. In step 268, a redemption request is provided to the issuing bank. In step 270, issuing bank transfers funds to the acquiring bank. In step 272, a transaction is confirmed to the transaction controller 12. In step 274, the user of the first mobile device 14 is provided with a bill. In this manner, an amount of credit may be exchanged and billed to the first user. Thus, credit from one user may be provided to the account of the other user and the amount may be indicated to the giving party as well as the receiving party. In this manner, transactions may be conducted for actual physical property or for digital content that is present on the giving party's device.

While particular embodiments of the invention have been shown and described, numerous variations and alternate embodiments will occur to those skilled in the art. Accordingly, it is intended that the invention be limited only in terms of the appended claims.

What is claimed is:

1. A transaction system comprising:
a merchant device;
a first mobile user device having a user interface for entering a security code, said security code enabling the device to communicate directly with the merchant device;
an issuing bank;
an acquiring bank; and
a transaction controller coupled to the first user, the merchant device, the issuing bank and the acquiring bank, said transaction controller verifying the first user, said transaction controller receiving a transaction amount corresponding to a transaction from the first user, authorizing the transfer of money to a merchant by transferring funds from the issuing bank to the receiving bank.

2. A transaction system as recited in claim 1 wherein communicating is performed directly though a wired or wireless connection.

3. A transaction system as recited in claim 1 wherein communicating is performed indirectly through a collection device.

4. A transaction system as recited in claim 1 wherein communicating is performed through a merchant device.

5. A transaction system as recited in claim 1 wherein the merchant device comprises a collection device.

6. A transaction system as recited in claim 1 wherein the merchant device comprises a stand alone point-of-sale device.

7. A transaction system as recited in claim 1 wherein the merchant device comprises a point-of-sale device wirelessly communicating with the transaction device.

8. A method of performing a transaction comprising:
entering a security code to enable a mobile device to communicate with a merchant device;
verifying the mobile user device at a transaction controller;
selecting a transaction amount on the mobile user device;
communicating the transaction amount from the mobile user device to the transaction controller; and
at the transaction controller, transferring the transaction amount to a merchant account.

9. A method as recited in claim 8 further comprising selecting from the first user device, selecting a first account or a second account to be used during transferring.

10. A method as recited in claim 9 wherein the first account is at a first bank and the second account is at a second bank.

11. A method as recited in claim 8 wherein communicating is performed directly though a wired or wireless connection.

12. A method as recited in claim 8 wherein communicating is performed indirectly through a collection device.

13. A method as recited in claim 8 wherein communicating is performed through a merchant device.

14. A method as recited in claim 13 wherein the merchant device comprises a collection device.

15. A method as recited in claim 13 wherein the merchant device comprises a stand alone point-of-sale device.

16. A method as recited in claim 13 wherein the merchant device comprises a point-of-sale device wirelessly communicating with the transaction device.

17. A method of configuring a mobile device for performing transactions comprising:
entering a security code to enable the mobile device to communicate with a merchant device;
installing a transaction application on the mobile device;
installing a digital identity certificate on the mobile device;
requesting an increase in a balance amount from a transaction controller; and
increasing the balance amount on the user device in response to the balance.

18. A method of performing a transaction comprising:
entering a security code to enable a mobile device to communicate with a point-of-sale device;
from the mobile user device, requesting a list of goods;
from a point-of-sale device, providing the list of goods;
from a mobile user device, selecting an item from the list of goods and transmitting an item selection and an amount of digital cash to the point-of-sale device;
from the point-of-sale device, confirming the amount of digital cash and issuing goods; and
in the mobile user device, reducing a balance in response to confirming the amount.

19. A method as recited in claim 18 further comprising from the point-of-sale device, generating a redemption request from a transaction controller;
from the transaction controller, confirming the redemption request; and
in response to confirming the redemption request, resetting the balance in the mobile user device.

20. A method as recited in claim 18 further comprising, transferring funds from a transaction controller to an acquiring bank.

21. A method as recited in claim 19 further comprising generating a transfer confirmation from the acquiring bank to the transaction controller.

22. A method as recited in claim 18 wherein the mobile user device comprises a cellular phone.

23. A method as recited in claim 18 wherein the mobile user device comprises a personal digital assistant.

24. A method as recited in claim 18 wherein prior to requesting a list of goods, initiating communication between a mobile user device and a point-of-sale device.

25. A method of performing a transaction comprising:
entering a security code to enable a mobile device to communicate with a merchant device;
from the mobile user device, requesting a list of goods;
providing a list of goods from an online store;
from a mobile user device, selecting an item from the list of goods to form a selection;
transmitting the selection and an amount of digital cash to the transaction controller;
from the transaction controller, verifying the digital cash and providing a confirmation to an online store;
from the online store, issuing the item; and
in the mobile user device, reducing a balance in response to issuing the item.

26. A method as recited in claim 25 further comprising sharing the item with a second mobile user device;
in response to sharing, notifying the transaction controller and billing the first user.

27. A method of performing a transaction comprising:
receiving a coupon at a mobile user device;
entering a security code to enable a mobile device to communicate with a point-of-sale device;
from the point-of-sale device, totaling an amount of goods;
transmitting the amount of goods to the mobile user device;
from a mobile user device, transmitting a coupon to the point-of-sale device;
transmitting an amount of digital cash to the point-of-sale device;
from the point-of-sale device, confirming the amount of digital cash and verifying the mobile user device with a transaction controller;
transferring funds from an acquiring bank to the transaction controller; and
in the mobile user device, reducing a balance in response to confirming the amount.

28. A method of performing a transaction comprising:
entering a security code to enable a mobile device to communicate with a merchant device;
from a mobile user device, requesting a list of goods;
from the point-of-sale device, providing a list of goods;
from a mobile user device, selecting an item from the list of goods and transmitting the item to the point-of-sale device;
from the point-of-sale device, confirming the mobile user through a transaction controller;
receiving a confirmation at the point-of-sale device from the transaction controller in the mobile user device, reducing a balance in response to confirming the amount.

29. A method as recited in claim 28 further comprising selecting from the first user device, selecting a first account or a second account for payment.

30. A method as recited in claim 29 wherein the first account is at a first bank and the second account is at a second bank.

31. A method as recited in 28 further comprising receiving a coupon from a point-of-sale device, totaling an amount of goods;
transmitting the amount of goods to the mobile user device;
from a mobile user device, transmitting a coupon to the point-of-sale device.

32. A method of performing a transaction comprising:
from a first mobile user device, selecting fund transfer;
verifying the first mobile user device at a transaction controller;
confirming an availability of funds from the transaction controller;
initiating a fund transfer from a first bank or account to a second bank or account; and
confirming the fund transfer from the first bank or account to the transaction controller.

33. A method of performing a transaction comprising:
entering a security code in a first mobile user device to enable a transaction scheme therein;
from the first mobile user device, selecting fund transfer to a second user device;
verifying the first mobile user device and the second mobile user device at a transaction controller;
confirming an availability of funds from the transaction controller; and
initiating a fund transfer from a first user account associated with the first mobile user device to a second user account associated with a second user device.
